(19) United States
(12) Patent Application Publication
(10) Pub. No.: US 2026/0106766 A1
(43) Pub. Date: Apr. 16, 2026

(54) APPARATUS AND METHOD FOR AUTOMATED ELECTRIC VEHICLE CHARGE ACTIVATION

(71) Applicant: Emobi Inc., San Francisco, CA (US)

(72) Inventors: Lin Sun FA, San Francisco, CA (US); Kabin NAM, San Francisco, CA (US); Christopher Everett, Beaverton, OR (US); Kei-Teng Low, Philadelphia, PA (US)

(21) Appl. No.: 19/353,011

(22) Filed: Oct. 8, 2025

Related U.S. Application Data
(60) Provisional application No. 63/706,561, filed on Oct. 11, 2024.
(60) Provisional application No. 63/714,046, filed on Oct. 30, 2024.

(51) Int. Cl. H04L 9/32; B60L 53/16; B60L 53/66; B60L 53/68; G07C 5/00

(52) U.S. Cl. CPC H04L 9/3263; B60L 53/16; B60L 53/66; B60L 53/68; G07C 5/008

(57) ABSTRACT

A machine has a network interface circuit to provide connectivity to a network in communication with an electric vehicle, a security validator machine, a secure database machine and a charging station management system. A memory stores instructions executed by a processor to store certificate chains from electric vehicle manufacturers, mobility operators and charging point operators. A trigger signal indicative of the electric vehicle connected to electric vehicle supply equipment (EVSE) is received. Proximate EVSEs are evaluated with a cascaded selection strategy including a first strategy based upon Media Access Control (MAC) addresses, a second strategy based upon Open Charge Point Protocol (OCPP) status, and a third strategy based upon a trained geolocation historical pairing model. The certificate chains are validated through network communications with the security validator machine and the secure database machine. An activation signal is sent to selected electric vehicle supply equipment.

### CROSS REFERENCES TO RELATED APPLICATIONS

This application claims priority to U.S. Provisional Patent Application 63/706,561, filed Oct. 11, 2024 and U.S. Provisional Patent Application 63/714,046, filed Oct. 30, 2024, the contents of which are incorporated herein by reference.

### FIELD OF THE INVENTION

This application relates to electric vehicle charging. More particularly, this invention is directed toward a system for automated electric vehicle charge activation.

### BACKGROUND OF THE INVENTION

Initiating an electric vehicle (EV) charging session presents significant friction in the user experience and remains one of the barriers to widespread EV adoption. Multiple standards and protocols have been developed over the past decade to address this challenge, including the Open Charge Point Interface (OCPI), Plug & Charge (ISO 15118-2/20, VDE-AR-E 2802-100-1), and AutoCharge (based on DIN SPEC 70121). While each has contributed meaningful advancements, such as secure certificate-based authentication, standardized roaming, or simplified initiation, none has achieved broad market penetration. The industry continues to face a fundamental tension between security, ease of use, and compatibility with legacy infrastructure, leaving drivers dependent on manual authentication methods thereby limiting seamless interoperability.

The Open Charge Point Interface (OCPI), first released in 2015, established a prevailing framework for backend interoperability between Charging Point Operators (CPOs) and eMobility Service Providers (eMSPs). OCPI has been instrumental in enabling roaming between networks, but it was never designed to provide fully automated session initiation. Drivers must still authenticate manually through mobile applications, RFID cards, or payment terminals. OCPI therefore represents an essential baseline for network interoperability, but it also highlights the need for a higher layer of automation to eliminate user intervention while maintaining trust and security.

ISO 15118-2, published in 2014, first introduced Plug & Charge over power-line communication (PLC) using X.509 certificates and Transport Layer Security (TLS) to authenticate the vehicle (EVCC) to the charging station (SECC). ISO 15118-20, published in 2022, consolidated and extended that framework to support bidirectional energy transfer, wireless charging, and advanced session orchestration. The security benefits of Plug & Charge are well established, as certificate-based authentication ensures tamper-resistant and verifiable identification. However, adoption has remained limited due to costly hardware and firmware upgrades. Legacy charging stations require communication controllers with PLC capability, secure elements for certificate storage, and sufficient compute capacity for cryptographic operations. For CPOs operating large fleets, these upgrade costs scale into millions of dollars of capital expenditure with uncertain return on investment. With a public infrastructure base still dominated by legacy AC and early-generation DC chargers, retrofitting at scale has proven impractical. OEMs, in turn, have been reluctant to implement ISO 15118 features in vehicles given the scarcity of compatible chargers, perpetuating a cycle of limited deployment.

AutoCharge®, based on DIN SPEC 70121, emerged as a pragmatic alternative. Instead of cryptographic certificates, AutoCharge identifies an EV most notably via the MAC address of the EV communication controller. This approach improves ease of deployment because it can be implemented with software changes and without adding PLC hardware. However, the reliance on MAC addresses creates severe security risks. Vehicles with static MAC addresses can be easily impersonated, as attackers can clone identifiers using basic network tools, enabling fraudulent charging. Meanwhile, many modern vehicles now employ dynamic MAC address randomization as a privacy safeguard, making them incompatible with AutoCharge systems that depend on stable identifiers. The lack of cryptographic validation, absence of revocation mechanisms, and exposure of persistent identifiers have raised concerns among CPOs and payment providers. These liabilities have prevented AutoCharge from achieving widespread deployment beyond pilot projects and closed ecosystems.

Supporting standards such as VDE-AR-E 2802-100-1:2019 provide comprehensive guidance on certificate lifecycle management, installation, and revocation procedures within the ISO 15118 framework. While these guidelines strengthen operational reliability and compliance, they do not resolve the fundamental trade-off between security (ISO 15118) and ease of use (AutoCharge), nor do they address the prohibitive costs of upgrading legacy infrastructure.

As a result, more than a decade after the publication of ISO 15118-2, the industry still lacks a universally adopted automated charging solution. CPOs resist the cost of large-scale retrofits, OEMs see little incentive to include Plug & Charge functionality in vehicles without corresponding infrastructure, and AutoCharge fails to meet the security requirements for commercial-scale deployment. This stalemate has left EV drivers dependent on manual authentication methods through OCPI-enabled systems, perpetuating the very friction that automated charging was intended to eliminate.

### SUMMARY

A machine has a network interface circuit to provide connectivity to a network in communication with an electric vehicle, a security validator machine, a secure database machine and a charging station management system. A processor is connected to the network interface circuit. A memory is connected to the processor. The memory stores instructions executed by the processor to store certificate chains from electric vehicle manufacturers, mobility operators and charging point operators. A trigger signal indicative of the electric vehicle connected to electric vehicle supply equipment (EVSE) is received. The certificate chains are validated through network communications with the security validator machine and the secure database machine. Proximate EVSEs are evaluated with a cascaded selection strategy including a first strategy based upon Media Access Control (MAC) addresses, a second strategy based upon Open Charge Point Protocol (OCPP) status, and a third strategy based upon a trained geolocation historical pairing model. An activation signal is sent to selected electric vehicle supply equipment.

### BRIEF DESCRIPTION OF THE DRAWINGS

The invention is more fully appreciated in connection with the following detailed description taken in conjunction with the accompanying drawings, in which:

FIG. 1 is a sequence diagram illustrating the secure certificate-based authentication system and method for electric vehicle charging session initiation according to an embodiment of the invention.

FIG. 2 is a sequence diagram illustrating the secure certificate-based authentication system and method for verifying an EVSE.

FIG. 3 depicts JustPlug's EVSE pairing flow: Candidate EVSES are selected by Haversine proximity to the calling EV, and pairing is attempted using up to 3 primary strategies: MAC address match, OCPP status match, and geolocation and estimator assisted match.

FIG. 4 is a state transition diagram illustrating the lifecycle states and transitions of a JustPlug charging session according to an embodiment of the invention.

FIG. 5 is a top-level diagram illustrating how all components in JustPlug are interconnected.

FIG. 6 illustrates a computer system configured in accordance with an embodiment of the invention.

Like reference numerals refer to corresponding parts throughout the several views of the drawings.

### DETAILED DESCRIPTION

The disclosed technology provides a streamlined approach to automated charging by solving the technical and operational constraints of existing solutions. Unlike Plug & Charge (ISO 15118), it does not rely on certificate transfer over Power Line Communication (PLC), eliminating the need for specialized hardware or firmware upgrades. Unlike AutoCharge® (DIN SPEC 70121), it preserves user privacy by avoiding the exchange of personally identifiable information. Fully compatible with legacy vehicles and chargers, the system requires no modifications on either side and operates without complex integrations or upgrade dependencies, enabling a secure and universally accessible automated charging experience.

The invention is disclosed in the context of the following definitions.
Charging Session: A charging session refers to the defined period of interaction between an electric vehicle (EV) and an electric vehicle supply equipment (EVSE) beginning when the EV is physically connected and authentication is initiated, and ending when the EV is disconnected or the supply of energy is terminated.
Charge Station Management System (CSMS): The backend software platform operated by a Charging Point Operator (CPO) to monitor, control, and manage electric vehicle supply equipment (EVSE). A CSMS typically handles tasks such as charger status reporting, remote diagnostics, pricing and tariff management, authorization of charging sessions, and communication with eMobility Service Providers (EMSPs) through protocols such as OCPI or OCPP.
AutoCharge®: A protocol for automated charging that identifies an Electric Vehicle (EV) using its MAC address instead of cryptographic certificates. It is simpler to implement on legacy hardware but has known security vulnerabilities.
Callback URL: A web address provided in an OCPI request. The receiving party (e.g., a CPO) uses this URL to send asynchronous, real-time updates back to the original sender (e.g., the JustPlug Hub) about the status of a long-running process, such as an OCPI Session.
Charging Point Operator (CPO): An entity that operates a network of charging stations (EVSEs).
Contract Certificate Bundle: A collection of digital certificates transmitted by the eMSP as described in the ISO 15118 standard. It contains the driver's eMAID and a hierarchical chain of certificates from the vehicle manufacturer (OEM) and the Mobility Operator (MO).
eMAID (eMobility Account ID): A globally unique identifier for a driver's contract, as defined by ISO 15118. It serves as the primary key to link the driver's certificate, the Token used in OCPI requests, and the resulting OCPI Session back to the corresponding JustPlugSession.
eMobility Service Provider (eMSP): An entity that provides EV charging services to drivers, such as payment processing and access to charging networks. Also referred to as a Mobility Operator (MO).
Electric Vehicle (EV): A vehicle that uses one or more electric motors for propulsion.
Electric Vehicle Supply Equipment (EVSE): The technical term for an EV charging station or charger.
Feature Vector: A structured set of numerical data points used as input for the trained estimator. It combines dynamic, real-time information (like distance and live status) with historical data (like aggregated coordinates and confidence scores) to represent the characteristics of a potential EV-to-EVSE pairing.
Independently Derived Positioning System (IDPS): A technology used to enrich raw geographical location data to provide a more precise, absolute position of an Electric Vehicle (EV) by taking into account continuous position changes, vehicle elevation, direction of travel and other data obtained from vehicle sensors in order to provide an aggregate position that is more reliable, accurate, and up-to-date than traditional GPS-based data.
ISO 15118: An international standard that defines the protocol for bidirectional digital communication between an EV and an EVSE, most notably enabling the Plug & Charge feature.
JustPlugSession: A record created and managed by the JustPlug system to track a single automated charging attempt from its initiation (PENDING state) through to its final outcome (COMPLETED or INVALID state).
Location: In the context of OCPI, a physical site (e.g., a parking garage) that contains one or more EVSEs.
MAC Address (Media Access Control): A globally unique 48-bit hexadecimal serial number assigned to a device's (EV's) network interface controller, serving as a digital identifier.
OCPI Session: The official record of a charging event as created and managed by a CPO within the OCPI framework. It is typically initiated in response to a START_SESSION command and is updated asynchronously throughout the charging process. The JustPlug system correlates this record with its own JustPlugSession to confirm a successful activation.
Open Charge Point Interface (OCPI): A standardized, open protocol that enables backend interoperability and roaming between Charging Point Operators (CPOs) and eMobility Service Providers (eMSPs).
Open Charge Point Protocol (OCPP): A standardized, open protocol that enables communication between an EVSE and a CPO's CSMS. It provides a more detailed, real-time operational status of the EVSE than OCPI.
Plug & Charge: A feature, standardized by ISO 15118, that allows for fully automated charging session initiation and billing through the secure exchange of digital certificates between the EV and the EVSE, typically over Power Line Communication (PLC).
Power Line Communication (PLC): A communication method that uses existing electrical power wiring to carry data. It is the standard communication medium for ISO 15118 Plug & Charge.
Roaming (OCPI): The ability for an EV driver registered with one eMSP to charge their vehicle at stations operated by a different, unaffiliated CPO. The OCPI protocol provides the technical framework that facilitates this interoperability, including authorization and billing data exchange between the two parties.
START_SESSION Command: A standard command within the OCPI protocol sent from an eMSP (or a hub acting on its behalf) to a CPO to request the initiation of a charging session at a specific EVSE for a driver identified by a Token.
Token: A digital identifier used within the OCPI protocol to represent the driver for authorizing a charging session. It is created by the system and linked to the driver's eMAID.
Trained Estimator: A machine learning model that has been trained on historical session data to predict the probability of a successful EV-to-EVSE pairing based on a given feature vector.
OBD Port II: The On-Board Diagnostics II (OBD-II) port is a standardized automotive interface that provides access to vehicle diagnostic data and telemetry signals, including status indicators such as plug-in detection or charging port activity.

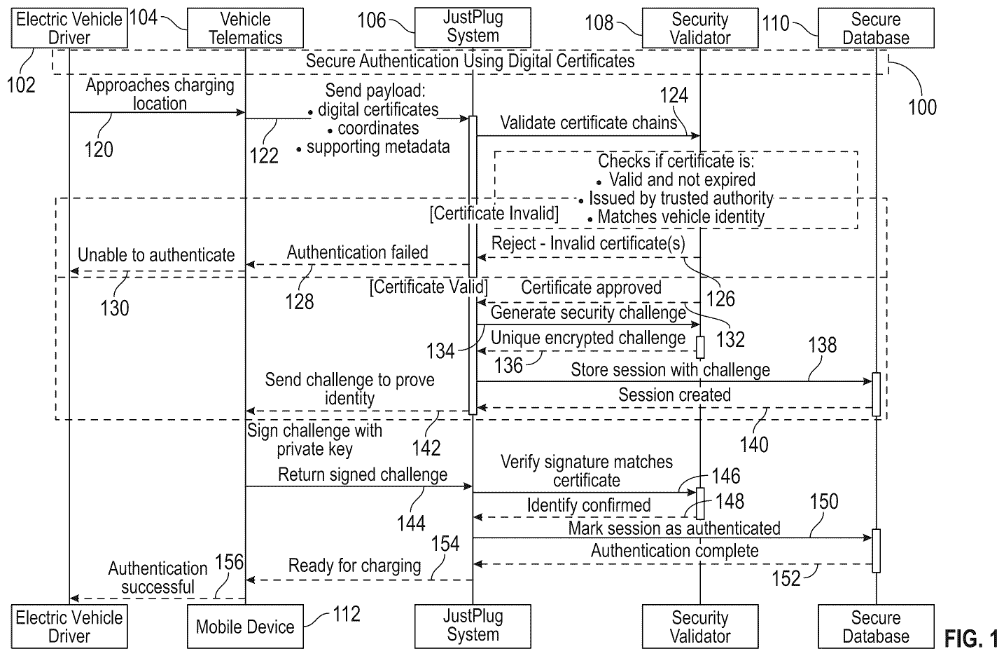

FIG. 1 illustrates secure authentication using digital certificates 100. Secure authentication includes the following participants: electric vehicle 102, vehicle telematics 104, JustPlug System 106, security validator 108, secure database 110 and optionally a mobile device 112. An electric vehicle 102 approaches a charging station 120. Vehicle telematics 104 send a payload 122, which may include digital certificates, coordinates and supporting metadata. The JustPlug System 106 attempts to validate the certificate chains 124 at security validator 108. The security validators may check that the certificates are valid and not expired, they are issued by a trusted authority and they match the vehicle identity. If validation is not achieved a signal 126 is sent to the JustPlug System 106, which sends an authentication failure signal 128 to the vehicle telematics 104 (or mobile device 112). A message 130 is then sent to the electric vehicle and/or driver 102.

If a certificate is validated, an approve signal 132 is sent to the JustPlug System 106, which generates a security challenge 134. The security validator 108 supplies 136 a unique encrypted challenge. The JustPlug System 106 sends a session and challenge information 138 to secure database 110. The secure database 110 sends a session created signal 140 to the JustPlug system 106, which sends the challenge 142 to the vehicle telematics 104, which returns a signed challenge 144. The security validator 108 verifies 146 that the signature matches the certificate. If the identity is confirmed 148, the JustPlug system 106 marks the session as authenticated 150 by advising the secure database 110. The secure database 110 provides a signal 152 of complete authentication to the JustPlug system 106, which sends a ready signal 154 to the vehicle telematics 104 and/or mobile device 112, which supply an authentication successful signal 156 to the electric vehicle 102.

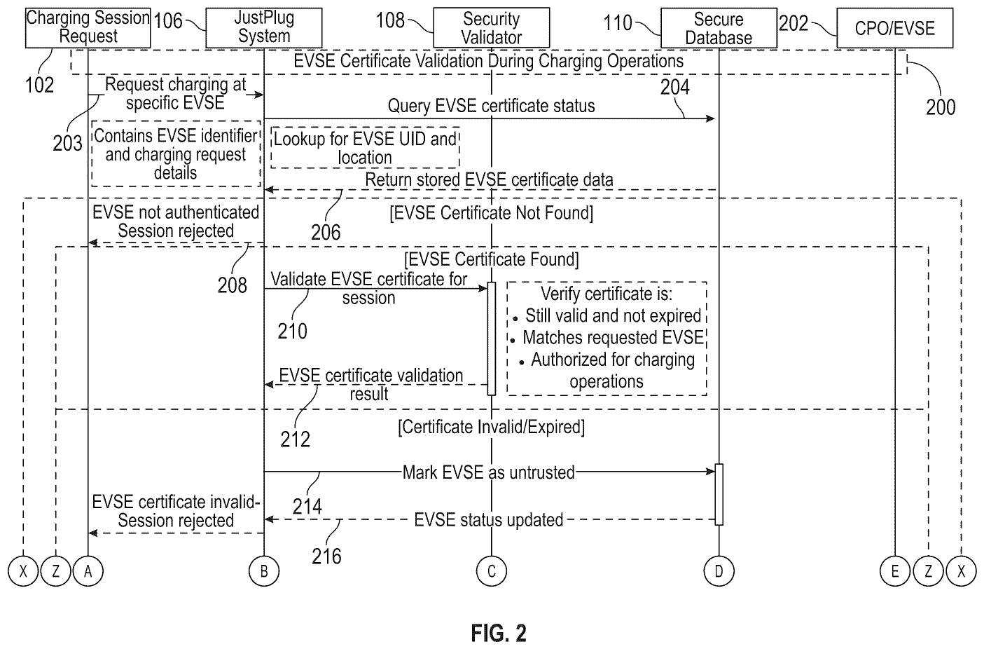

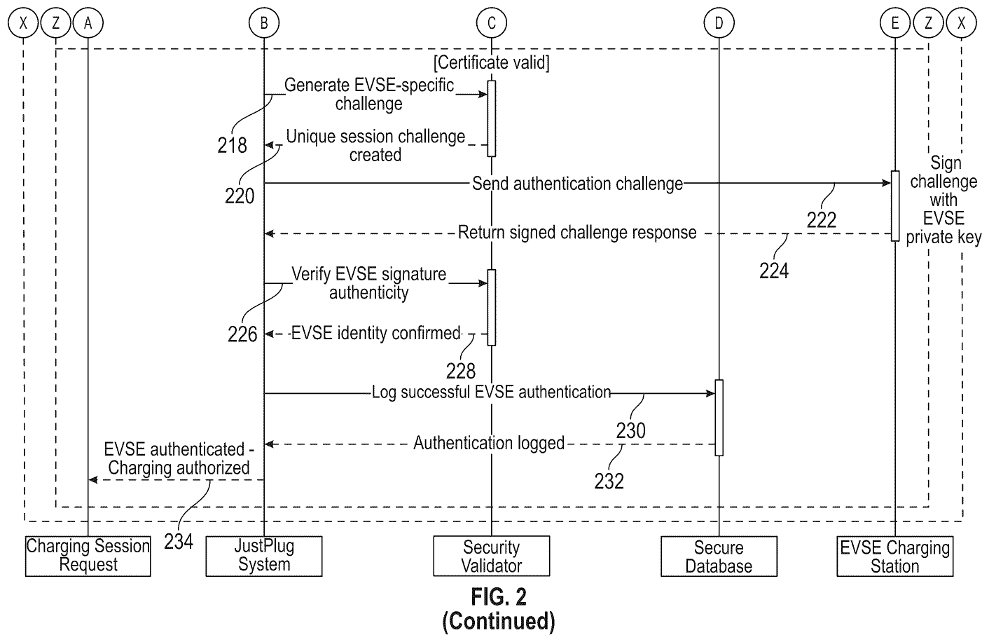

FIG. 2 illustrates electric vehicle supply equipment (EVSE) certificate validation 200 in accordance with an embodiment of the invention. The validation process involves an electric vehicle 102 that forms the charge request, the JustPlug System 106, the security validator 108, the secure database 110, and a charging point operator (CPO) or EVSE 202.

The electric vehicle 102 makes a charging request 203 at specific EVSE. The JustPlug System 106 queries 204 the EVSE certificate status. The secure database 110 returns the stored EVSE certificate data 206. In the event of certificate failure, the JustPlug System 106 sends an EVSE not authenticated session signal 208 to the electric vehicle 102. In the event of successful authentication, the JustPlug System 106 validates 210 the EVSE certificate at the security validator 108. The security validator 108 sends an EVSE certificate validation result 212. In the event of an invalid or expired certificate, the JustPlug System 106 sends an untrusted signal 214 to the secure database 110. The secure database 110 returns a status update 216 to the JustPlug system 106. In the event of a valid certificate, the JustPlug System 106 generates an EVSE-specific challenge 218 for the security validator 108. The security validator 108 sends a signal 220 indicating that a unique session challenge is created. The JustPlug System 106 sends the authentication challenge 222 to the CPO/EVSE 202, which returns a signed challenge response 224. The JustPlug System 106 sends an EVSE signature authenticity signal 226 to the security validator 108, which sends a confirmation response 228. The JustPlug System 106 then sends a successful authentication signal 230 to the secure database 110, which supplies an a authentication logged signal 232 to the JustPlug System 106, which sends an authentication signal 234 to the electric vehicle 102.

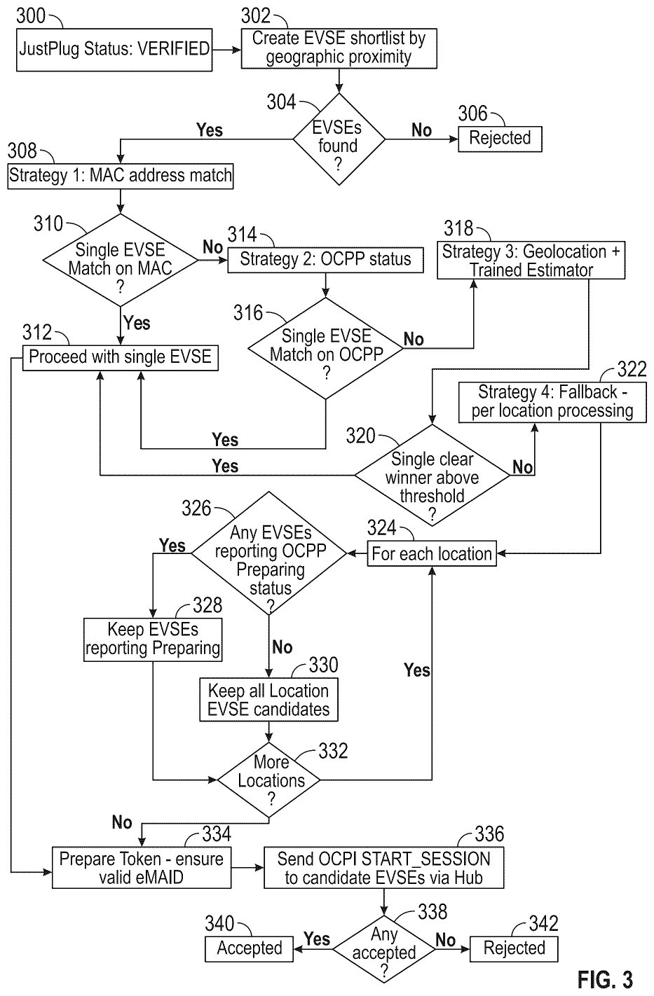

FIG. 3 depicts JustPlug's EVSE pairing flow using different strategies. Initially, the JustPlug Status is verified 300. An EVSE list is created based on geographic proximity 302. If no EVSEs are found (304—No), the request is rejected 306. If EVSEs are found (304—Yes), an initial strategy of matching by MAC address is used 308. If there is a single EVSE match on the MAC address (310—Yes), charging commences at the single EVSE 312. Otherwise (310—No), a second strategy of Open Charge Point Protocol (OCPP) status 314 is used. If this results in a single EVSE match (316—Yes), charging commences 312. Otherwise (316—No), a third strategy of geolocation and trained estimator 318 is used. If this results in a single clear winner (320—Yes), charging commences 312. Otherwise (320—No) a fourth strategy of per location processing 322 is used. For each location 324 it is determined whether any EVSE reports OCPP preparing status 326. If so (326—Yes) EVSE reporting preparing is maintained 328. If not (326—No), all EVSE candidates at the location are kept 330. If there are more locations (332—Yes), control returns to block 324.

Otherwise, (332—No), a token is prepared to ensure valid eMAID 334. OCPI START_SESSION signal is sent to the CPO to request activation of the remaining candidate EVSE(s) 336. If accepted (338—Yes), charging commences 340. Otherwise, charging is rejected 342.

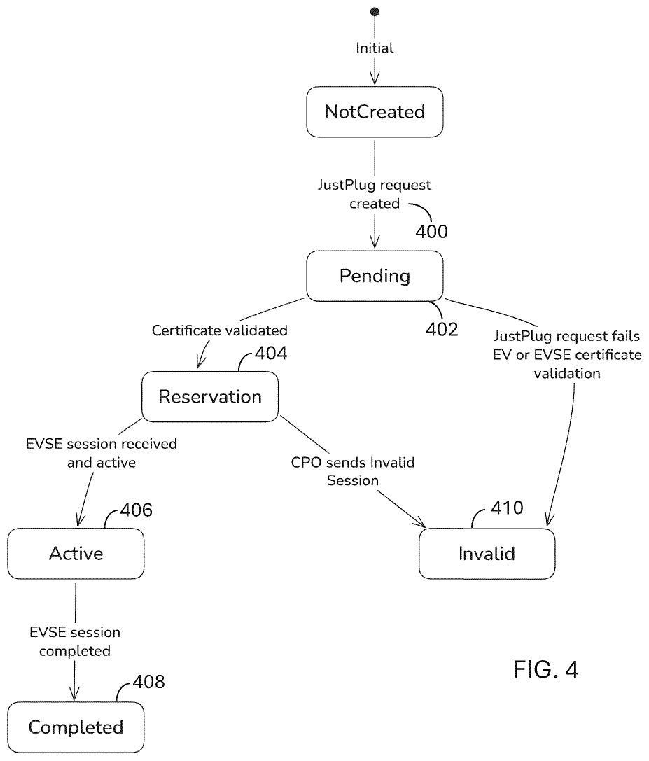

FIG. 4 is a state transition diagram illustrating the lifecycle states and transitions of a JustPlug charging session according to an embodiment of the invention. A JustPlug request is created 400 and then pends 402. The request transitions to an invalid state 410 if the initial certificate validation fails or if, after validated, the Charging Point Operator (CPO) signals that the session is invalid. If the initial certificate is validated, the system issues a cryptographic challenge. Upon successful validation of the signed challenge response from the vehicle, the session transitions to a verified state, indicating a reservation 404. The session becomes active 406 once the system confirms that a corresponding charging session has been initiated by the CPO. The active session then proceeds until the charging event is completed 408

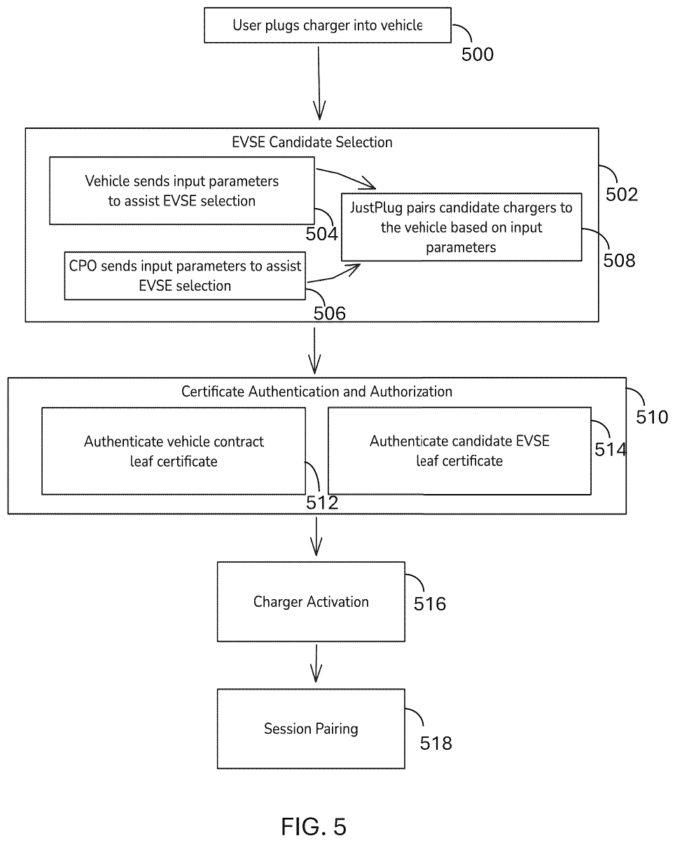

FIG. 5 is a top-level diagram illustrating how all components in JustPlug are interconnected. A user plugs a charger into a vehicle 500. This results in EVSE candidate selection 502. Candidate selection begins with the vehicle sending input parameters to assist EVSE selection 504. CPO sends input parameters to assist EVSE selection 506. JustPlug pairs candidate chargers to the vehicle based on input parameters 508. After an EVSE candidate is selected authentication transpires 510. The vehicle contract is authenticated 512 and the candidate EVSE is authenticated 514. Charger activation commences 516, resulting in a session pairing 518.

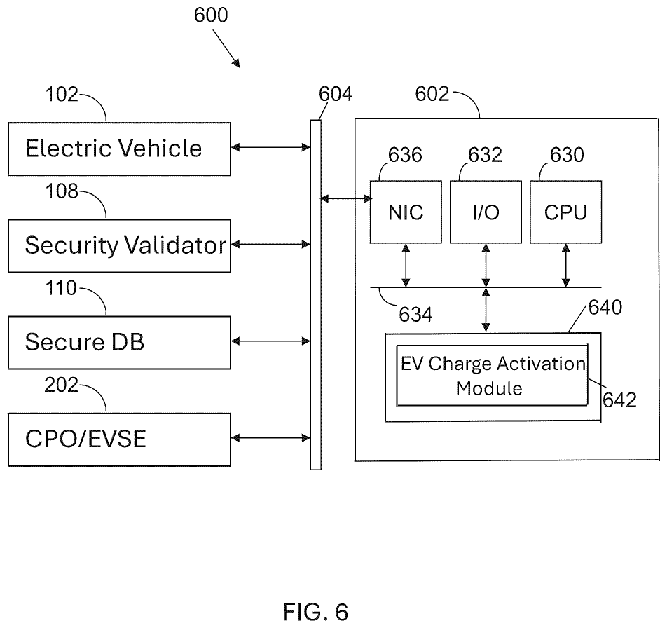

FIG. 6 illustrates a computer system 600 configured in accordance with an embodiment of the invention. The system 600 includes an EV Charge Activation server 602 in connection with a network 604, which may be any combination of wired and wireless networks. Server 602 corresponds to the previously discussed JustPlug System 106. The server has a processor 630 and input/output devices 632 connected by a bus 634. A network interface circuit 636 is also connected to the bus to provide connectivity to network 604. A memory 640 is also connected to the bus. The memory 640 stores an EV charge activation module 642 with instructions executed by processor 630 to implement the operations of FIGS. 1-5. These operations are performed through connections on network 604, to electric vehicle 102, security validator 108, secure DB 110 and CPO/EVSE 202. Each of those machines has a processor, input/output devices, a network interface circuit, and a memory storing instructions executed by a processor, as discussed in connection with server 602.
1. The foregoing operations are more fully appreciated with the following discussion of specific standards and circumstances.
Plug & Charge Certificate setup is required as a pre-requisite to using JustPlug
   a. However, unlike Plug & Charge, the OEM and CPO certificates do not need to be installed within the EV and EVSE, respectively.
   b. These certificate chains will be stored securely in the JustPlug system, in order to support authentication when the Contract Certificate Bundle is sent by the eMSP.
2. An EV driver arrives at a charging location and physically connects the charging cable from the EVSE to their vehicle.
3. The EV initiates a communication setup sequence with the EVSE to determine what protocols are mutually supported between the two devices.
4. If ISO 15118-2/20 protocols are mutually supported, the EV and EVSE proceed with standard certificate exchange through Power Line Communication (PLC) following the established message sequence outlined in ISO 15118-2/20 standards.
5. If ISO 15118-2/20 protocols are not supported or fail to establish communication, this is where JustPlug fills in the gap. JustPlug is initiated by one of the following trigger signals:
   a. The EV telemetry data sending the plugged-in signal or open charging port signal through a device that is plugged into the OBD port II
   b. The vehicle manufacturers (EV OEM), or from a fleet manager, sending telemetry data of plugged-in signal or open charging port signal
6. JustPlug lacks the knowledge of the exact EVSE that will be activated, so the JustPlug system goes through a selection process to narrow down the potential EVSEs, which we will call EVSE Candidate Selection
7. Geographic data and absolute positioning of the EV—enriched by Independently Derived Positioning System (IDPS) or similar technology—and digital certificate, MAC address of the EV, and other unique identifiers for the EV (such as the eMAID) are sent to the JustPlug System.
   a. The digital Certificate is provided to facilitate the Certificate Exchange between caller (eMSP) and the JustPlug system.
   b. The Media Access Control (MAC) address can be used as a primary indicator during EVSE Candidate Selection and Activation: Strategy 1.
      This MAC address is a globally unique 48-bit hexadecimal serial number which is assigned to an EV's network interface controller as a digital ‘nametag’. No two devices worldwide can be assigned the same MAC address.
   c. The geographic data, enriched by IDPS or similar technology to provide absolute positioning of the EV, is used throughout the EVSE Candidate Selection and Activation process.
      Technologies such as IDPS provide an enriched geographical position of the EV by taking into account continuous position changes, vehicle elevation, direction of travel and other data obtained from vehicle sensors in order to provide an aggregate position that is more reliable, accurate, and up-to-date than traditional GPS-based data.
8. EVSE Candidate Selection and Activation (pairing the EV to EVSE and sending OCPI START_SESSION).
   a. Asynchronous Real-time EVSE Updates
      Context: Beyond the typical OCPI related fields, JustPlug's CPO partners can provide real-time updates (push) and/or on-demand data (pull) pertaining to two important features:
         1. OCPP Status: The current operational status of an EVSE (OCPP status). This status, typically reserved for communication between EVSEs and CPO CSMS via Open Charge Point Protocol (OCPP), provides finer-grained detail regarding the current state of an EVSE than what is defined for CPO to eMSP communications in OCPI protocol.
         Most notably for JustPlug, an OCPP status of “Preparing” indicates when an EV has been plugged into the charger itself.
         This “Preparing” state is leveraged by JustPlug to assist in pairing the calling EV with the correct EVSE match.
         Further, the last_updated field provides a reliable time-stamp indicating when an EVSE transitioned into the OCPP “Preparing” status (time EV was plugged in).
         2. EV MAC address: A globally unique identifier for the EV is received by the EVSE as part of the initial authorization between the vehicle and charger upon plugging the vehicle in. The EVSE then reports this EV MAC address, along with other identifiers and status change, to the CSMS where it is stored.
         When a vehicle is plugged into an EVSE, the CPO can report the MAC address of the engaged vehicle along with the OCPP status transition into “Preparing” to JustPlug either during realtime updates (push) or on-demand (pull).
         The currently engaged EV's MAC address can be compared against a MAC address provided by the eMSP caller during a JustPlug session initiation signal for near-perfect EVSE-EV pairing.
   b. EVSE enumeration and candidate narrowing
      Context: After driver authentication, the system identifies plausible charging sites near the driver's reported geolocation using a configurable search radius and forming a candidate short list containing all known EVSEs in the vicinity.
         If no candidate EVSEs are found, the activation flow terminates and the request is rejected.
      JustPlug then attempts to pair the calling EV with an EVSE by utilizing up to four strategies in strict order detailed below: MAC address match, OCPP status/temporal match, Geographic position+estimator assisted match, and a fallback multiple-EVSE activation strategy.
         If at any point in the cascade a single EVSE candidate remains, JustPlug proceeds to the Token Preparation and Activation protocol.
      Strategy 1—MAC address match (highest confidence)
         Context: The MAC address of an EV is globally unique and thus can provide the highest confidence indicator of which EVSE the calling eMSP is attempting to activate if a CPO reports that a matching MAC address is currently engaged with an EVSE.
         1. The MAC address of the calling EV, is provided by the eMSP during the JustPlug session request signal.
         2. If any short-listed candidate EVSE is managed by a CPO that reports the MAC address of vehicles that have plugged in, JustPlug will compare the EV MAC address currently engaged with the candidate EVSE against the MAC address of the calling EV—This CPO reported EV MAC address can be reported to the JustPlug system either during regular OCPI updates or on demand. If the latter, JustPlug will directly request the current state of the EVSE from the CPO via OCPI communication.
         If a MAC address match is found, JustPlug breaks from the cascade and proceeds to the Token Preparation and Activation protocol steps.
         If no match is made, or in the rare case that multiple matches are found due to operator-noise, JustPlug proceeds to Strategy 2.
      Strategy 2—OCPP status and timing correlation
         Context: An EVSE's OCPP status of “Preparing” indicates that a vehicle has been plugged into the device but no session has yet begun. When an EVSE is reporting an OCPP status of “Preparing”, the EVSE's last_updated timestamp indicates at which time the charger was plugged into an EV. This specific status can be a strong indicator of which EVSE the calling eMSP is attempting to activate.
         1. If all short-listed candidate EVSEs are managed by a CPO that reports the OCPP status, JustPlug will filter the EVSE candidate list to prefer any EVSE reporting a “Preparing” status.
         2. Of the remaining candidates, the last_updated time stamp of each EVSE is compared against the timestamp associated with the eMSP's JustPlug initiation request and the candidate list is filtered further to those reporting a last_updated timestamp falling within a configurable range.
         If exactly one EVSE is matched in this way, JustPlug breaks from the cascade and proceeds to the Token Preparation and Activation protocol steps.
         If no match is made, or in the rare case that some candidates are managed by a CPO that does not report OCPP status, JustPlug proceeds to Strategy 3.
      Strategy 3—Geolocation+Trained Estimator (model-assisted)
         Context: If a single EVSE cannot be identified through high-confidence identifiers like a MAC address match or precise timing correlation, the system leverages a trained estimator. This strategy uses a combination of historical data and real-time signals to compute a probability score for each remaining candidate, enabling an intelligent, data-driven pairing decision.
         1. For each EVSE remaining on the candidate shortlist, the system prepares a feature vector. This vector is a structured set of data points that combines dynamic information from the current request with persistent historical data associated with the EVSE. The feature vector includes:
         The great-circle distance between the calling EV's current reported geographical location and the EVSE's location.
         The EVSE's historically aggregated central coordinate and its corresponding confidence score, if a refined historical record exists.
         The EVSE's current OCPP status (e.g., “Preparing”, “Available”), which provides a real-time signal of its readiness.
         2. Each candidate's feature vector is processed by the trained estimator, which returns a probability score between 0.0 and 1.0. This score represents the estimator's confidence that the specific EVSE is the correct match for the current request.
         3. The system analyzes the returned scores. If one EVSE receives a score that exceeds a configurable confidence threshold and is significantly higher than any other candidate's score, it is identified as the clear winner.
         If exactly one such EVSE is identified, JustPlug breaks from the cascade and proceeds to the Token Preparation and Activation protocol steps.
         If no candidate meets the confidence threshold or if multiple candidates return similarly high scores, JustPlug proceeds to Strategy 4.
      Strategy 4—Fallback Activation (multi-EVSE)
         1. If multiple EVSE candidates remain, proceed with multiple EVSE activation requests.
         2. The system prefers EVSEs reporting an OCPP “Preparing” state.
         3. Prioritizing “Preparing” EVSEs increases success, reduces driver time-to-charge, and minimizes spurious attempts.
         4. This path is expected to diminish as historical data and the estimator improve.
   c. Token preparation (driver identity)
      Context: The operator needs a valid token to identify the driver and authorize the charging session.
      The system ensures a valid Token exists for the user's eMAID, keyed to the system's eMSP identity.
      If a Token is not present, the system creates one and marks it as valid and whitelisted.
      Significance and definition of eMAID: The eMAID links the driver's Contract Certificate, the Token in OCPI requests, and the OCPI Session, serving as the primary key to correlate the operator's OCPI Session back to the JustPlugSession.
   d. Activation protocol (standardized OCPI via the JustPlug Hub)
      Context: With EVSE candidates identified and the driver token prepared, the system requests that the operator begin a charging session.
      For each candidate EVSE, the JustPlug Hub sends an OCPI Commands START_SESSION request to the EVSE's operator (CPO).
      Each request includes:
         1. The eMSP Token, carrying the driver's eMAID and the target Location/EVSE identifiers.
         2. A Hub callback URL for asynchronous OCPI Session updates.
      The operator responds to each OCPI request with an acceptance or rejection; the system records the outcome.
      If at least one OCPI START_SESSION request is accepted, the overall activation result is accepted. If all requests are rejected or no EVSEs were contacted, the result is rejected.
9. EV Certificate exchange (certificate creation, setup, cryptography, etc)
   a. Create (certificate exchange)
      The eMSP must transmit a Contract Certificate Bundle as described in ISO 15118, which will contain an eMAID and a chain of certificates from the vehicle manufacturer (OEM) and Mobility Operator (MO). In addition to the certificate bundle the geographic coordinates of the driver will also be sent for EVSE candidate selection.
      The system performs hierarchical certificate chain validation to verify that the certificates in the bundle are valid, not expired, issued by a trusted certificate authority, and correspond to the authentic vehicle identity.
      Upon successful certificate validation, the system generates a unique cryptographic challenge (a unique 32-byte random string), which is then stored in a secure database along with session metadata. The system then transmits this challenge back to the eMSP.
   b. Validate (signature validation)
      The eMSP cryptographically signs the challenge (Section 8, 6a) using the vehicle's private key associated with the Contract Certificate Bundle.
      The signed challenge is returned to the JustPlug System in the Validate API endpoint, where the system verifies that the signature corresponds to the previously validated certificate, thereby confirming the vehicle's authentic identity.
      Upon successful verification, the system updates the session status in the Secure Database to indicate successful authentication and notifies the eMSP that the vehicle is ready for charging session initiation.
10. EVSE certificate validation process
   a. Create
      Charge Point Operator (CPO) registers new charging station hardware with the JustPlug system. The process begins when the CPO installs physical EVSE hardware and submits the associated digital certificates through their backend system to the JustPlug platform.
      The JustPlug system performs comprehensive certificate chain validation, verifying that each EVSE certificate is valid, unexpired, issued by a trusted certificate authority, and corresponds to the authentic hardware identity of the charging station.
      Upon successful validation, the system generates EVSE-specific trust credentials and securely stores the certificate data, hardware identity, location metadata, and verification status in the database, effectively establishing the charging station as a trusted participant in the JustPlug network.
   b. Validate
      When a charging session request targets a specific EVSE, the JustPlug system queries its database to retrieve the stored certificate data for that charging station.
      It then performs real-time certificate validation, checking for expiration, authenticity, and operational authorization. If the certificate remains valid, the system generates a unique session-specific challenge and transmits it to the CPO or the physical EVSE station, which responds by cryptographically signing the challenge using its private key.
      The system verifies this signature to confirm the EVSE's authentic identity before authorizing the charging session.
11. JustPlugSession Assignment Scenarios (lifecycle)
   a. States and Transitions
      i. PENDING: A JustPlugSession is created with driver's eMAID and coordinates; a cryptographic challenge is issued.
      ii. VERIFIED: The driver signs the challenge, and the system verifies the signature, proving control of the private key.
      iii. ACTIVE: Set when an OCPI Session created by the operator (CPO) is first observed by the JustPlug Hub and matched to this JustPlugSession.
      iv. COMPLETED: Set when a matched OCPI Session reaches a terminal “completed” condition. The OCPI Session is then linked to this JustPlugSession.
      v. INVALID: Set if signature validation fails (from PENDING), or when a matched OCPI Session reaches a terminal “invalid” condition (from ACTIVE). Invalid sessions are not linked.
   b. Hub-Mediated OCPI Session Handling
      i. After OCPI START_SESSION, the operator creates and updates an OCPI Session asynchronously.
      ii. The JustPlug Hub receives OCPI Session creations and updates from the operator and persists them.
      iii. For each new or updated OCPI Session, the Hub attempts to match it to a JustPlugSession using core rules.
   c. Activation Recognition (VERIFIED→ACTIVE)
      i. Context: The moment JustPlug recognizes the operator has begun a real charging session corresponding to the JustPlug setup.
      ii. Technical Flow:
         1. Trigger: The Hub observes that the operator has created a new OCPI Session in response to an OCPI START_SESSION request.
         2. Matching Rule (core):
         Compares the driver identifier (eMAID/contract_id) in the OCPI Session to the eMAID stored on the JustPlugSession. Values must be identical.
         Compares timestamps: JustPlugSession creation time must fall within a bounded window centered on the OCPI Session's start time.
         If multiple JustPlugSessions satisfy rules, the Hub selects the one with the earliest creation time. Additional domain context may be applied.
         3. Action: Updates JustPlugSession status from VERIFIED to ACTIVE. OCPI Session is not yet permanently linked; linkage is deferred until a terminal outcome is observed.
   d. Terminal Recognition (ACTIVE→COMPLETED or INVALID)
      i. Context: When the Hub learns, from operator's OCPI updates, that the charging session has finished.
      ii. Technical Flow:
         1. Triggers: The Hub receives later OCPI updates indicating a terminal condition (e.g., completed or invalid).
         2. Matching Rule:
         Compares eMAID/contract_id. Values must be identical.
         Compares timestamps: JustPlugSession creation time must fall within the bounded window centered on the OCPI Session's start time.
         If multiple JustPlugSessions satisfy rules, the Hub selects the one with the earliest creation time. Additional domain context may be applied.
         3. Actions:
         If the session completed successfully, the system sets JustPlugSession status to COMPLETED and permanently links the OCPI Session.
         If the session ended unsuccessfully and the JustPlugSession is ACTIVE, the system sets JustPlugSession status to INVALID. Unsuccessful operator sessions are not permanently linked.
         4. Handling Multiple Operator Sessions (edgecase): If more than one OCPI Session is reported for the same JustPlugSession, the JustPlug system keeps record of this. Terminal OCPI Sessions are recorded and linked. JustPlugSessions associated with multiple OCPI sessions are excluded from downstream analytics and model training.
   e. On-Demand Reconciliation
      i. Context: Ensures an up-to-date state if a client queries a JustPlug session while OCPI updates are in flight.
      ii. When a client fetches an ACTIVE JustPlugSession, if a matching OCPI Session in the expected time window has already reached a terminal status, the Hub updates the JustPlugSession's status to reflect that outcome.
   f. Housekeeping
      i. Context: Background maintenance to prevent internal handles and states from remaining indefinitely “open.”
      ii. Hub creates internal callback handles (“Hub sessions”) that are marked INVALID on a schedule (e.g., after 24 hours) if they exceed a freshness threshold.
      iii. JustPlugSessions older than a defined retention period (e.g., 2 days) and not in a terminal state are marked INVALID.
12. Self-Learning Feedback Loop and Memory Map
   a. The JustPlug system incorporates a self-learning feedback loop designed to continuously improve the accuracy of EV-to-EVSE pairing over time. This process transforms historical session data into predictive intelligence, enabling the system to transition from a purely rule-based approach to a more precise, model-assisted methodology.
   b. Context: The initial pairing of a vehicle to an EVSE relies on foundational rules such as geospatial proximity and, when available, real-time OCPP status. While effective, this approach does not account for historical trends or subtle variations in geographical location data. The self-learning feedback loop addresses this by creating a persistent, evolving memory of successful charging events.
   c. Data Collection and Ground Truth Establishment:
      The foundation of the learning system is the establishment of “ground truth” data. A successful pairing is confirmed only when a JustPlugSession initiated by a user is definitively linked, via temporal correlation and matching eMAID, to a single OCPI Session that proceeds to a COMPLETED state.
      These confirmed pairings, containing the user's initial geographical location and the specific EVSE that was successfully activated, serve as high-quality records of successful outcomes.
   d. Historical Data Aggregation and Refinement:
      The system periodically and asynchronously processes the collected ground truth records. For each unique EVSE across the network, it aggregates the geographical locations from all historical successful pairings associated with it.
      This aggregation involves statistical analysis to calculate a refined, high-precision central coordinate for the EVSE and a corresponding confidence score. The central coordinate represents the most probable location of a successful connection, filtering out the noise from individual location reporting inaccuracies. The confidence score quantifies the quality of this data, increasing with the number of successful sessions and the tightness of their geographic clustering.
      This process creates a persistent, historical record that maps each EVSE to its statistically proven activation zone and data reliability.
   e. Estimator Training and Intelligence Generation:
      The refined historical data is used to periodically train a predictive estimator. The training process teaches the estimator to differentiate between the characteristics of successful and unsuccessful pairing scenarios.
      The estimator learns to weigh a combination of dynamic, real-time features (e.g., the distance from a user's current position to an EVSE's refined central coordinate, the EVSE's live OCPP status) and historical features (e.g., the confidence score of the EVSE's data).
      By training on vast numbers of both successful pairings (positive examples) and plausible but incorrect alternatives (negative examples), the estimator becomes highly adept at identifying the single most likely EVSE for a given set of inputs.
   f. Model-Assisted Pairing in Real-Time:
      Once trained, the estimator is deployed to assist in live pairing decisions. When a new charging request is initiated, the system utilizes the estimator as part of its cascaded pairing logic. The estimator provides a precise probability score for each candidate EVSE, allowing the system to select the most likely match with high confidence.
   g. Continuous Improvement Loop: This entire process creates a virtuous cycle. Every new successful charging session provides another data point that is fed back into the aggregation process. This, in turn, refines the historical record and provides richer data for retraining the estimator, ensuring the system's pairing intelligence becomes progressively more accurate and reliable over time.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A machine, comprising:
a network interface circuit to provide connectivity to a network in communication with an electric vehicle, a security validator machine, a secure database machine and a charging station management system operated by a charging point operator to monitor, control and manage electric vehicle supply equipment (EVSE),
a processor connected to the network interface circuit; and
a memory connected to the processor, the memory storing instructions executed by the processor to:
store certificate chains from electric vehicle manufacturers, mobility operators and charging point operators thereby eliminating a need for the electric vehicle and EVSE to store the certificate chains,
receive a trigger signal indicative of the electric vehicle connected to electric vehicle supply equipment, where the trigger signal includes geographic coordinates for the electric vehicle,
validate the certificate chains through network communications with the security validator machine and the secure database machine,
evaluate proximate EVSE with a cascaded selection strategy including a first strategy based upon Media Access Control (MAC) addresses, a second strategy based upon Open Charge Point Protocol (OCPP) status, and a third strategy based upon a trained geolocation historical pairing model, and
send an activation signal to selected electric vehicle supply equipment.

2. The machine of claim 1 wherein the MAC addresses include an eMobility Service Provider (eMSP) provided MAC address and Charging Point Operator (CPO) MAC addresses.

3. The machine of claim 2 wherein the MAC addresses are matched by:
receiving a globally unique 48-bit hexadecimal MAC address from the eMSP,
comparing the globally unique 48-bit hexadecimal MAC address against electric vehicle MAC addresses reported by CPOs through real-time updates or on-demand queries, and
selecting the selected electric vehicle supply equipment when an exact MAC address match is found.

4. The machine of claim 1 wherein OCPP status includes preparing status.

5. The machine of claim 4 wherein OCPP status is evaluated by:
filtering candidate electric vehicle supply equipment reporting preparing status,
comparing the last updated timestamp of each electric vehicle supply equipment against an initiation request timestamp, and
selecting the EVSE whose last updated timestamp falls within a configurable temporal range.

6. The machine of claim 1 wherein the trained geolocation historical pairing model
uses feature vectors for each candidate electric vehicle supply equipment, each feature vector including great-circle distance between the electric vehicles reported location and electric vehicle supply equipment locations, historically aggregated central coordinate and confidence scores, and current OCPP status of electric vehicle supply equipment,
processes the feature vectors through a trained estimator to generate probability scores between 0.0 and 1.0, and
selecting electric vehicle supply equipment exceeding a configurable confidence threshold.

7. The machine of claim 1 further comprising a fourth cascaded selection strategy of
preferring electric vehicle supply equipment reporting OCPP preparing status,
transmitting parallel start session requests to multiple candidate EVSEs, and
accepting activation when at least one electric vehicle supply equipment node accepts a request.

8. The machine of claim 1 wherein the trigger signal is received from at least one of:
electric vehicle telemetry data indicating a plugged-in signal or open charging port signal through an On-Board Diagnostics II (OBD-II) device,
vehicle manufacturer telemetry data indicating a plugged-in signal or open charging port signal, and
fleet manager telemetry data.

9. The machine of claim 1 further comprising a session management module configured to track sessions through states comprising pending, verified, active, completed and invalid.

10. The machine of claim 1 further comprising an asynchronous real-time electric vehicle supply equipment update module configured to:
receive push updates or provide on-demand pull capabilities for OCPP status changes,
capture when electric vehicle supply equipment transitions to preparing status with associated timestamps,
receive electric vehicle supply equipment MAC addresses reported by electric vehicle supply equipment during initial authorization, and
provide real-time data to an electric vehicle supply equipment candidate selection processor.

11. The machine of claim 1 further comprising a self-learning feedback loop module configured to: establish ground truth data from sessions definitively linked to single OCPP sessions reaching a completed state,
aggregate geographical locations from successful pairings for each unique EVSE,
calculate refined central coordinates and confidence scores through statistical analysis, and
periodically train a predictive estimator using aggregated historical data.

12. The machine of claim 11 wherein the confidence scores increase based on
the number of successful sessions associated with electric vehicle supply equipment, and
the tightness of geographic clustering of historical successful connections.

13. A method for automated electric vehicle charger activation, comprising:
detecting a trigger signal indicating an electric vehicle is physically connected to electric vehicle supply equipment;
receiving geographic coordinates and a contract certificate bundle;
performing certificate validation by validating the contract certificate bundle against stored original equipment manufacturer and charging point operator certificate chains, generating a unique cryptographic challenge, transmitting the unique cryptographic challenge to an eMobility Service Provider (eMSP), receiving a signed challenge response, and verifying a signature using a private key of an electric vehicle;
identifying candidate EVSE within a configurable radius using a cascaded selection strategy including a first strategy based upon Media Access Control (MAC) addresses, a second strategy based upon Open Charge Point Protocol (OCPP) status, and a third strategy based upon a trained geolocation historical pairing model, and
sending an activation signal to selected electric vehicle supply equipment.

14. The method of claim 13, wherein detecting the trigger signal comprises receiving at least one of:
telemetry data from a device detecting a plugged-in signal,
telemetry data from a vehicle manufacturer system detecting an open charging port signal, and telemetry data from a fleet management system.

15. The method of claim 13, wherein MAC addresses matching comprises:
receiving a globally unique 48-bit hexadecimal MAC address,
comparing the globally unique 48-bit hexadecimal MAC address against electric vehicle MAC addresses reported by charging point operators through real-time updates or on-demand queries, and
selecting the selected electric vehicle supply equipment when an exact MAC address match is found.

16. The method of claim 13 wherein OCPP status is evaluated by:
filtering candidate electric vehicle supply equipment reporting preparing status,
comparing the last updated timestamp of each electric vehicle supply equipment against an initiation request timestamp, and
selecting the EVSE whose last updated timestamp falls within a configurable temporal range.

17. The method of claim 13 wherein the trained geolocation historical pairing model operates
using feature vectors for each candidate electric vehicle supply equipment, each feature vector including great-circle distance between the electric vehicles reported location and electric vehicle supply equipment locations, historically aggregated central coordinate and confidence scores, current OCPP status of electric vehicle supply equipment,
processing the feature vectors through a trained estimator to generate probability scores between 0.0 and 1.0, and
selecting electric vehicle supply equipment exceeding a configurable confidence threshold.

18. The method of claim 13 further comprising a fourth cascaded selection strategy of
preferring electric vehicle supply equipment reporting OCPP preparing status,
transmitting parallel start session requests to multiple candidate EVSEs, and
accepting activation when at least one electric vehicle supply equipment node accepts a request.

19. The method of claim 13 further comprising tracking sessions through states comprising pending, verified, active, completed and invalid.

20. The method of claim 13 further comprising:
establishing ground truth data from sessions definitively linked to single OCPI sessions reaching a completed state,
aggregating geographical locations from successful pairings for each unique EVSE,
calculating refined central coordinates and confidence scores through statistical analysis, and
training a predictive estimator using aggregated historical data.
